(19) United States
(12) Patent Application Publication
(10) Pub. No.: US 2014/0326653 A1
(43) Pub. Date: Nov. 6, 2014

(54) METHOD AND APPARATUS FOR WATER PURIFICATION

(71) Applicant: Chin-Yu Huang, Taipei (TW)

(72) Inventor: Chin-Yu Huang, Taipei (TW)

(73) Assignee: TAIWELL TECH. CO.,LTD., Taipei (TW)

(21) Appl. No.: 14/269,064

(22) Filed: May 2, 2014

(30) Foreign Application Priority Data
May 2, 2013 (TW) 102208135
May 21, 2013 (TW) 102209447

(51) Int. Cl. C02F 1/00; C02F 5/00; C02F 1/28; C02F 9/00

(52) U.S. Cl. CPC C02F 1/003; C02F 9/005; C02F 1/00; C02F 5/00; C02F 1/283; C02F 2307/06
USPC 210/259; 210/511

(57) ABSTRACT

A water purification system may include a water purification unit and a clean water receiving unit. The water purification unit includes a purification space that has a sealing unit at a predetermined position and communicating with outside the water purification unit. The purification space has a receiving space containing liquid with resonating molecules, wherein a purification channel is formed between an outer wall of the receiving space and the purification space, and the purification space has at least one water inlet and one water outlet, and the water inlet is connected to a water source. The clean water receiving unit that has a clean water receiving space that has at least one clean water inlet and clean water outlet, wherein the clean water inlet is connected to the water outlet of the purification space to receive clean water that has been processed by the water purification unit.

### FIELD OF THE INVENTION

The present invention relates to a method and apparatus for water purification, and more particularly to utilizing energy generated by molecular resonance to soften and purify water.

### BACKGROUND OF THE INVENTION

On Earth, sunlight, air and water are three elements of life, and in the human body, water is about 60 to 70% thereof. Recently, due to the increase of population and industrial development, urban sewage, industrial wastewater and aquaculture wastewater causes different degrees of water pollution. Thus, people are more concerned about water safety and quality. Nowadays, most companies and homes have water purification equipment to obtain cleaner and healthier water. However, most water purification equipment takes up a lot of spaces, and in order to obtain clean and healthy drinking water, people need to spend some money on the water purification equipment, which becomes a burden to someone who has limited budget. Therefore, there remains a need for a new and improved method and apparatus for water purification to overcome the problems stated above.

### SUMMARY OF THE INVENTION

The problem the present invention wants to solve is that most water purification equipment takes up a lot of spaces, and in order to obtain clean and healthy drinking water, people need to spend some money on the water purification equipment, which becomes a burden to someone who has limited budget.

In one aspect, a water purification assembly may include a purification space that has a sealing unit at a predetermined position and communicating with outside. The sealing unit has a bolt, a cover and a through hole. The cover is secured at one screw end of the purification space and the bolt passes through the through hole. The purification space has a receiving space that can be cylindrical, and the receiving space contains liquid with resonating molecules, which is configured to disperse energy to miniaturize the size of the water molecules to further purify the water. More specifically, the liquid has been processed so the molecules thereof resonate at a predetermined frequency to generate energy. A purification channel is formed between an outer wall of the receiving space and the purification space, and the purification space has at least one water inlet and one water outlet, wherein the water inlet is connected to a water source with a pipe and the pipe is from a wall surface. The water purification assembly may also include a clean water receiving unit that has a clean water receiving space that has at least one clean water inlet and clean water outlet, wherein the clean water inlet is connected to the water outlet of the purification space to receive clean water that has been processed by the water purification assembly.

In another aspect, the water can be purified by a simple apparatus containing liquid with resonating molecules. A purification stirring rod has a rod body that has a handle on one end, and a stir on the other end, and the rod body has a receiving space. The rod body can be made by metal, PVC or PE. The stir is used to stir a sample liquid in a carrier, and the liquid with resonating molecules is located in the receiving space of the rod body. Likewise, the liquid has been processed so the molecules thereof resonate at a predetermined frequency to generate energy for water purification.

In a further aspect, a water purification system may include a body including a base and a front cover covering the base. One side of the body has a water inlet and water outlet, and the base has a first filtering unit, a second filtering unit, a third filtering unit, a fourth filtering unit, a fifth filtering unit and a sixth filtering unit.

In one embodiment, the filter of the first filtering unit has an ultra-high density fiber; the filter of the second filtering unit has food-grade ions; the filter of the third filtering unit has high-quality activated carbon particles; the filter of the fourth filtering unit has KDF activated carbon particles; and the filter of the sixth filtering unit is made by advanced ceramic.

### BRIEF DESCRIPTION OF THE DRAWINGS

FIG. 1 illustrates a three-dimensional view of the water purification system in the present invention.

FIG. 2 illustrates an exploded view of the water purification system in the present invention.

FIG. 3 illustrates a sectional view of the water purification system in the present invention.

FIG. 4 illustrates a sectional view of another embodiment of the water purification system in the present invention.

FIG. 5 illustrates another sectional view of another embodiment of the water purification system in the present invention.

FIG. 6 illustrates a sectional view of a further embodiment of the water purification system in the present invention.

FIG. 7 illustrates a sectional view of an alternative embodiment of the water purification system in the present invention.

FIG. 8 illustrates a sectional view of still a further embodiment of the water purification system in the present invention.

FIG. 9 illustrates a sectional view of still an alternative embodiment of the water purification system in the present invention.

FIG. 10 illustrates a sectional view of still another embodiment of the water purification system in the present invention.

FIG. 11 illustrates a schematic view of the purification apparatus in the present invention.

FIG. 12 a three-dimensional view of one embodiment of the purification apparatus in the present invention.

FIG. 13 a three-dimensional view of the embodiment of the purification apparatus in FIG. 12 when in use.

FIG. 13 a three-dimensional view of the embodiment of the purification apparatus in FIG. 12 when in use.

FIG. 14 illustrates a schematic view of another embodiment the purification apparatus in the present invention.

FIG. 15 illustrates a schematic view of a further embodiment the purification apparatus in the present invention.

FIG. 16 illustrates a schematic view of an alternative embodiment the purification apparatus in the present invention.

FIG. 17 illustrates a schematic three-dimensional view of the appearance the water purification system in the present invention.

FIG. 18 illustrates a schematic three-dimensional view of the inner structure of the water purification system in the present invention.

FIG. 19 illustrates a sectional view of the water purification system in the present invention.

FIG. 20 illustrates another sectional view of the water purification system in the present invention.

FIG. 21 illustrates a sectional view of the water purification system in the present invention when in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

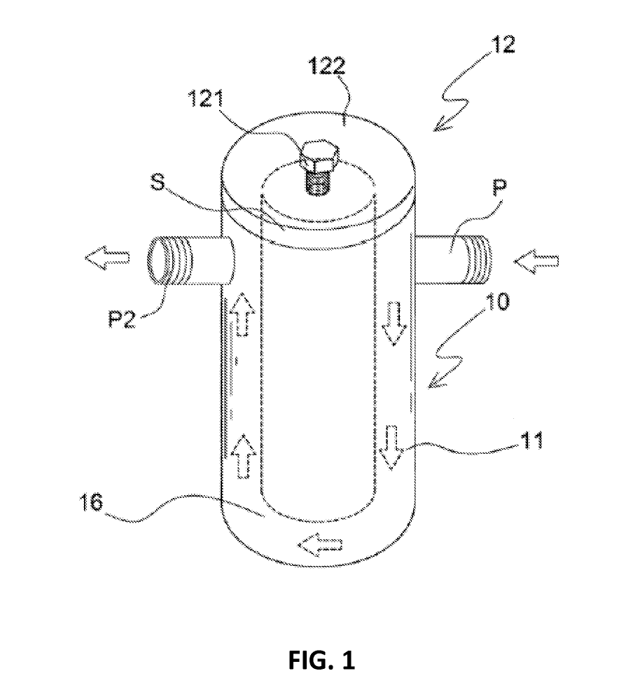

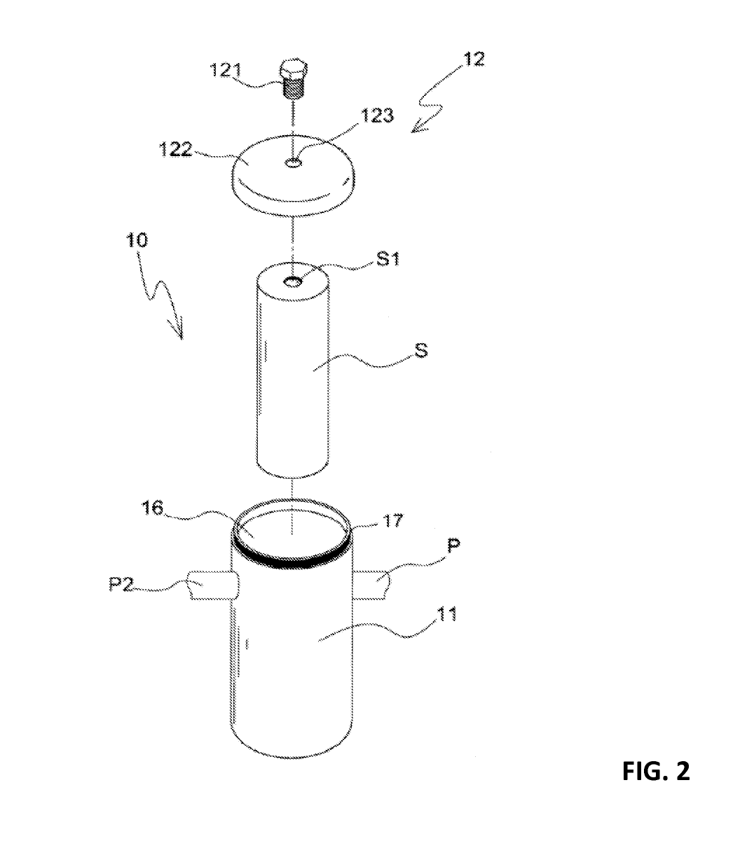

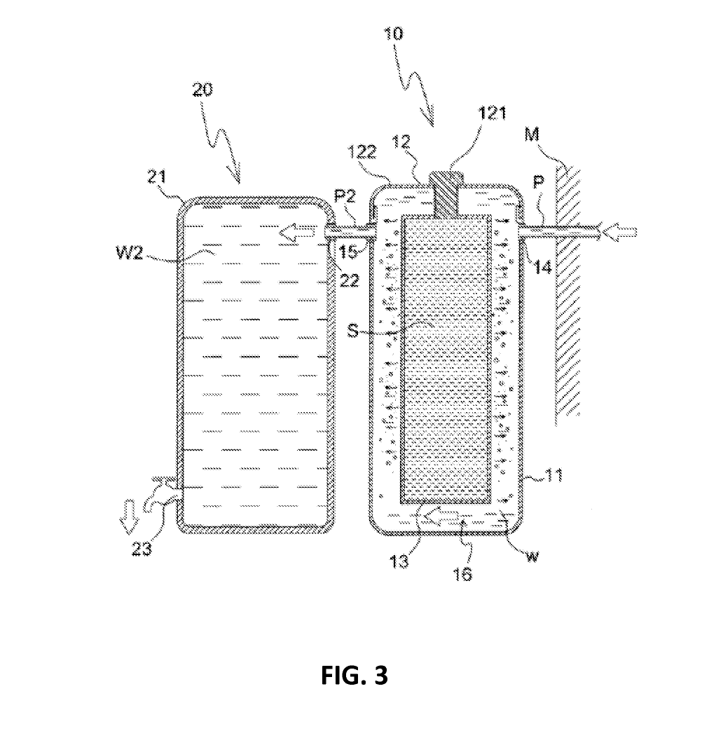

In one aspect, referring to FIGS. 1 to 3, a water purification assembly (10) may include a purification space (11) that has a sealing unit (12) at a predetermined position and communicating with outside. The sealing unit (12) has a bolt (121), a cover (122) and a through hole (123). The cover (122) is secured at one screw end (17) of the purification space (11) and the bolt (121) passes through the through hole (123). The purification space (11) has a receiving space (13) that can be cylindrical, and the receiving space (13) contains liquid (S) with resonating molecules, which is configured to disperse energy to miniaturize the size of the water molecules to further purify the water. More specifically, the liquid (S) has been processed so the molecules thereof resonate at a predetermined frequency to generate energy. A purification channel (16) is formed between an outer wall of the receiving space (13) and the purification space (11), and the purification space (11) has at least one water inlet (14) and one water outlet (15), wherein the water inlet (14) is connected to a water source (W) with a pipe (P) and the pipe (P) is from a wall surface (M). The water purification assembly (10) may also include a clean water receiving unit (20) that has a clean water receiving space (21) that has at least one clean water inlet (22) and clean water outlet (23), wherein the clean water inlet (22) is connected to the water outlet (15) of the purification space (11) to receive clean water (W2) that has been processed by the water purification assembly (10).

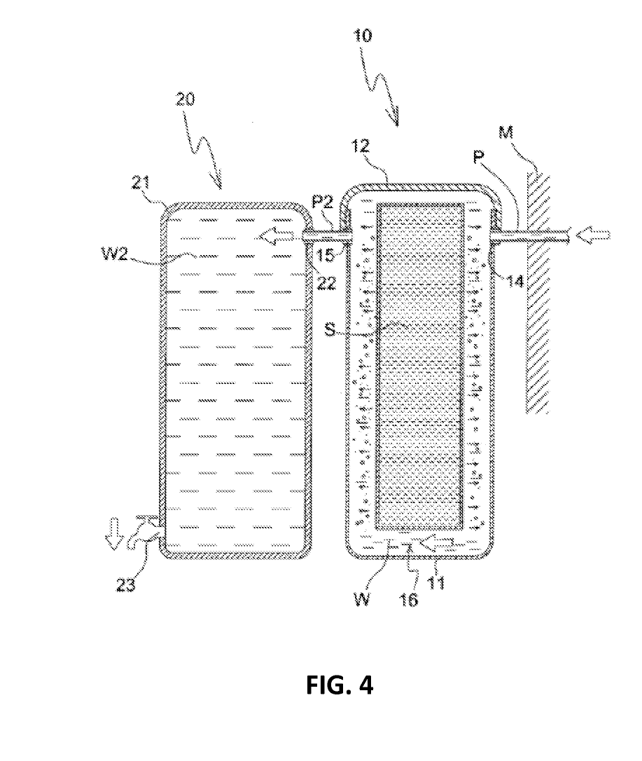

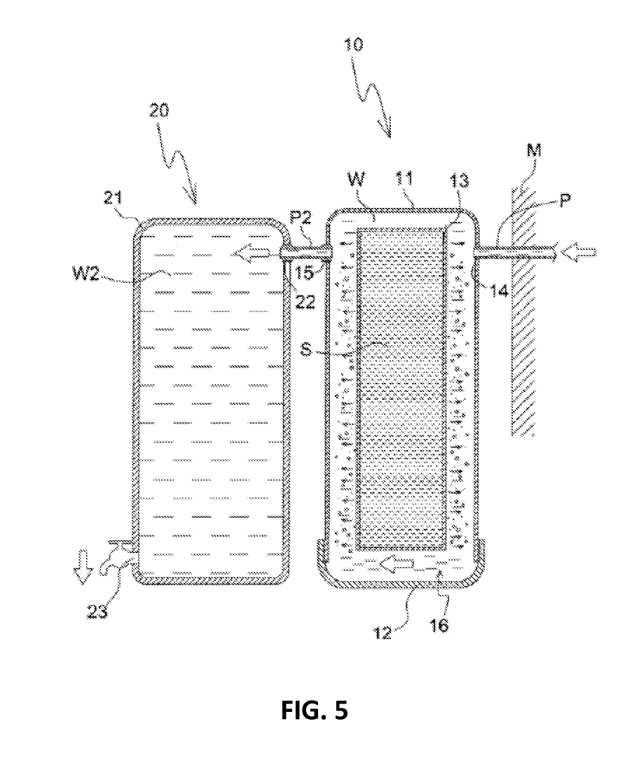

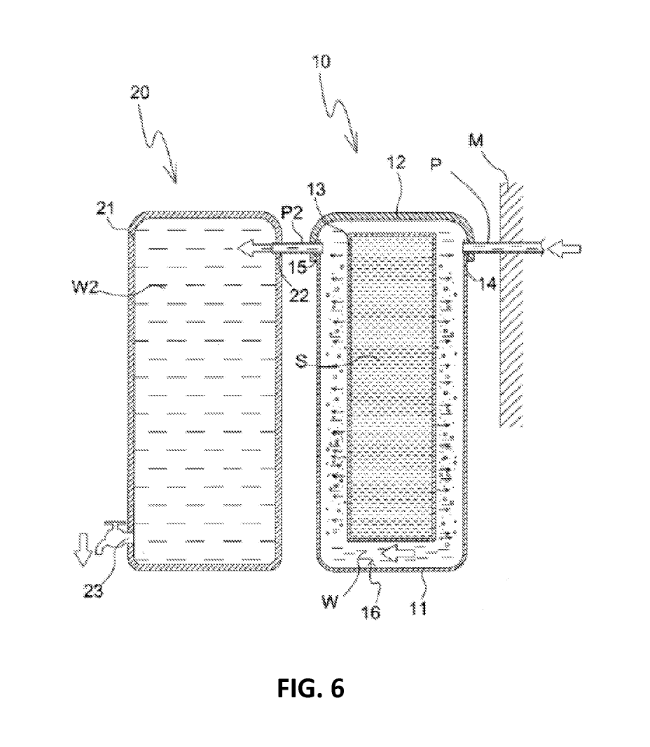

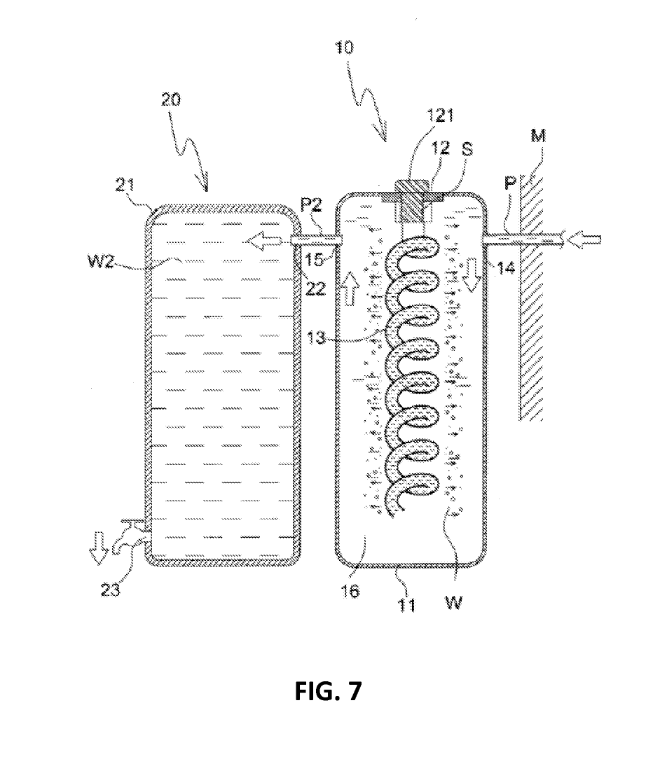

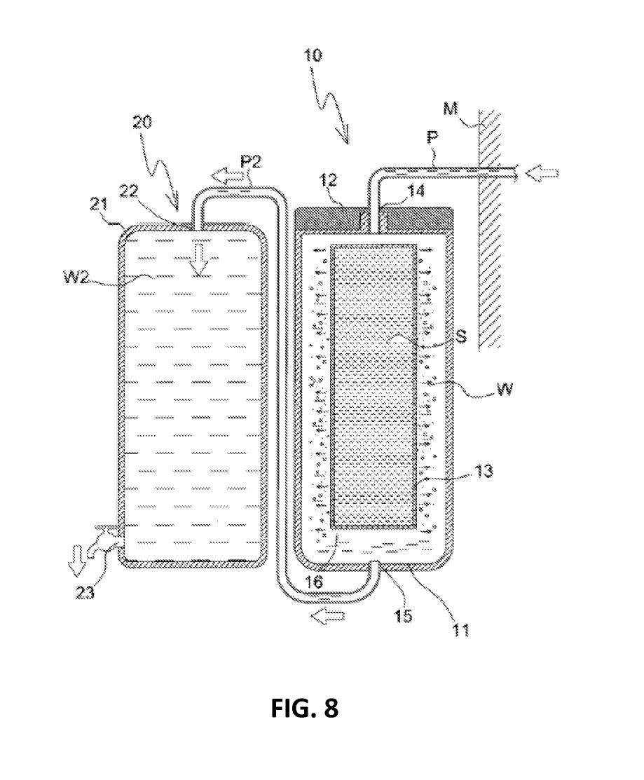

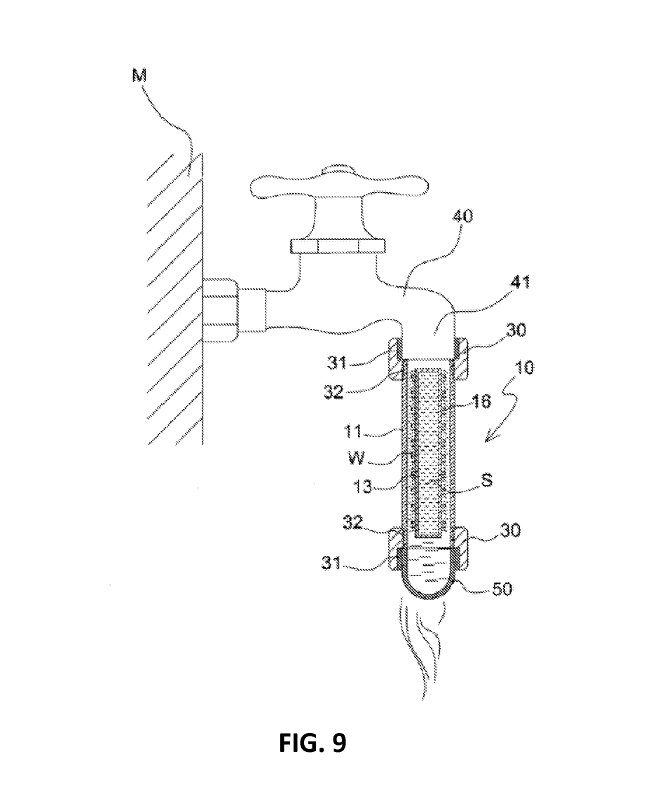

In one embodiment, referring to FIGS. 4 and 5, the sealing unit (12) can be a spiral unit secured at either an upper or a lower portion of the purification space (11). Referring to FIG. 6, the water inlet (14) and the water outlet (15) of the purification space (11) can connect to a predetermined position of the sealing unit (12). Referring to FIG. 7 for another embodiment, the receiving space (13) is of a spiral shape. Referring to FIG. 8 to a further embodiment, the water inlet (14) and the water outlet (15) of the purification space (11) can be disposed at a top and bottom surface of the purification space (11). Referring to FIG. 9 for still a further embodiment, the water purification assembly (10) is connected to a faucet outlet (41) of a faucet (40), wherein each of both ends of the water purification space (11) has a securing portion (32) of a connector (30), and one connector (30) has a positioning portion (31) to position at the faucet outlet (41) of the faucet (40), and a filter (50) is disposed at the other end of the connector (30), so the water (W) from the faucet (40) can flow through the purification channel (16) in which the molecules of the water (W) can be miniaturize and the water (W) can thus be purified.

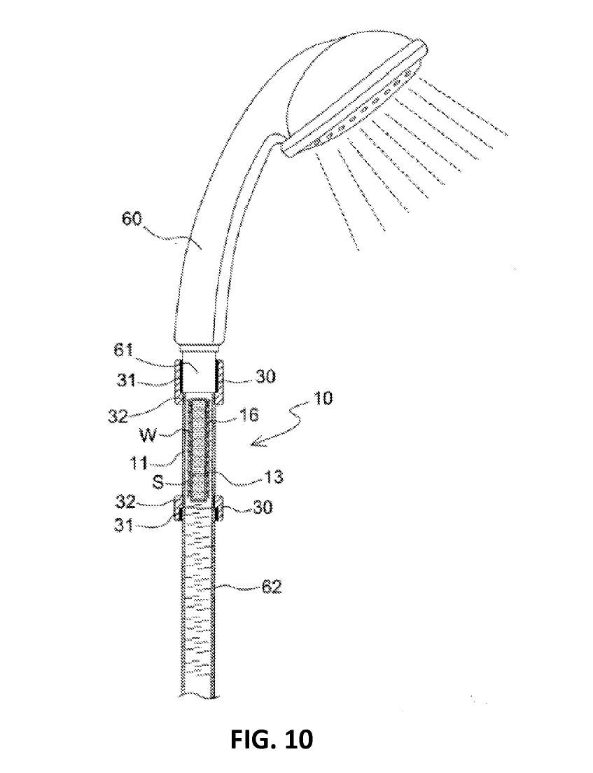

Referring to FIG. 10, the water purification assembly (10) can be connected to a shower water inlet (61) of the shower head (60), wherein each of both ends of the water purification space (11) has a securing portion (32) of a connector (30), and one connector (30) has a positioning portion (31) to position at the shower water inlet (61) of the shower head (60), and a shower water outlet (62) is disposed at the positioning portion (31) of the other connector (30), so the water (W) from the shower (60) can flow through the purification channel (16) in which the molecules of the water (W) can be miniaturized and the water (W) can thus be purified.

According to the embodiments stated above, the liquid (S) with resonating molecules in the receiving space (13) of the water purification assembly (10) is configured to disperse energy to purify the water. When water (W) flows through the purification channel (16), the energy can be dispersed from the wall of the receiving space (13) to miniaturize the molecular size of the water to further purify the water. This water purification process is simple, convenient and fast comparing with conventional water purification systems.

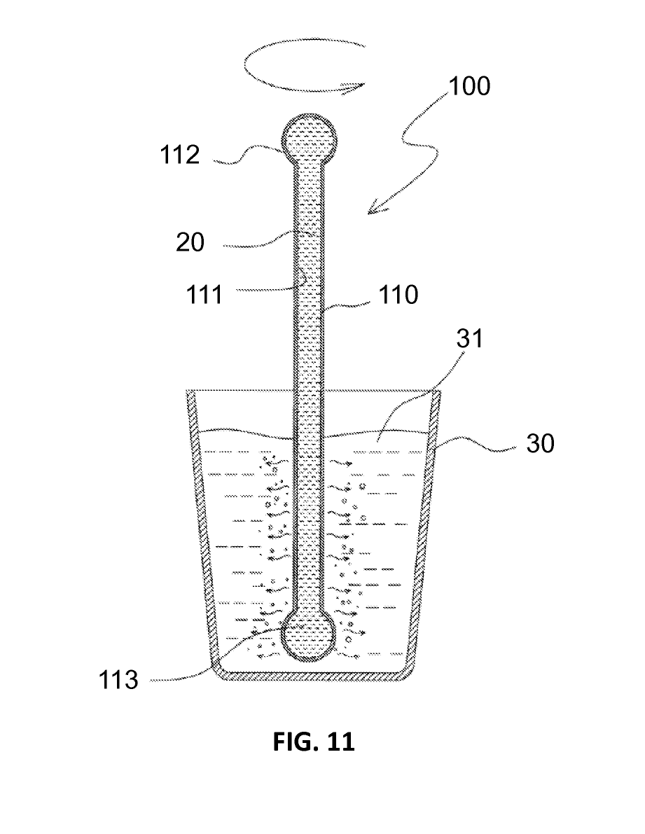

In another aspect, the water can be purified by a simple apparatus containing liquid with resonating molecules. Referring to FIGS. 11 to 16, a purification stirring rod (100) has a rod body (110) that has a handle (112) on one end, and a stir (113) on the other end, and the rod body (110) has a receiving space (111). The rod body (110) can be made by metal, PVC or PE. The stir (113) is used to stir a sample liquid (31) in a carrier (30), and the liquid (20) with resonating molecules is located in the receiving space (111) of the rod body (10). Likewise, the liquid (20) has been processed so the molecules thereof resonate at a predetermined frequency to generate energy for water purification.

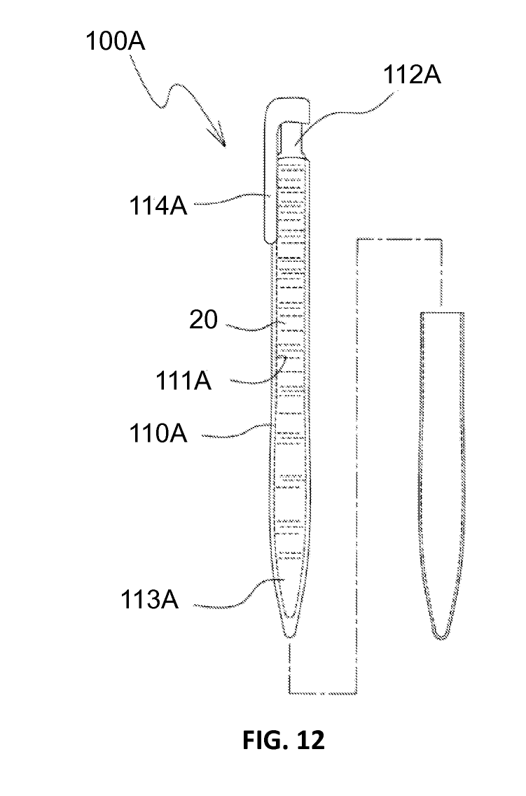

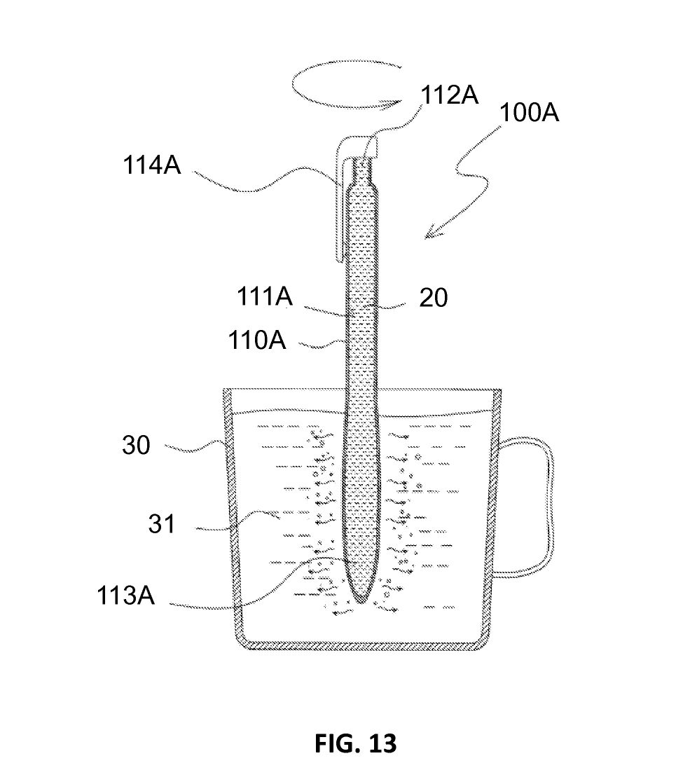

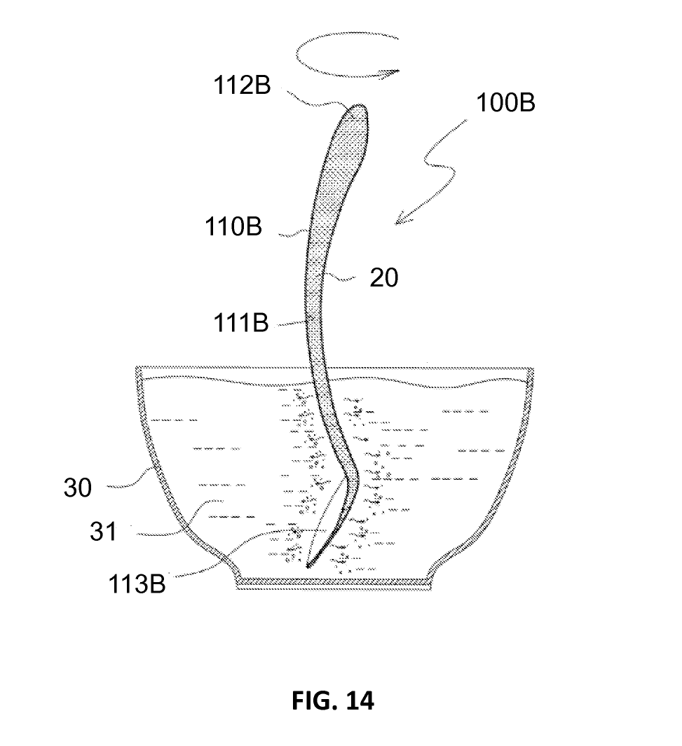

As shown in FIGS. 12 and 13, a purification stirring rod (100A) has a pen-shaped body (110A) that has a handle (112A) with a hanging unit (114A) that can be used to secure the rod (100A) on the user's clothing. The pen-shaped body (110A) has the handle (112A) on one end, and a stir (113A) on the other end, and a receiving space (111A) is located inside the pen-shaped body (110A). The liquid (20) with resonating molecules is received in the receiving space (111A), and when the pen-shaped body (110A) is being stirred in the sample liquid (31) in the carrier (30), the liquid (20) with resonating molecules disperses energy from a wall of the pen-shaped body (110A) to soften and purify the sample liquid (31). Referring to FIG. 14, a purification stirring rod (100B) has a spoon-shaped body (110B) with a handle (112B) and a stir (113B), and the liquid (20) with resonating molecules is received in a receiving space (111B) inside the spoon-shaped body (110B).

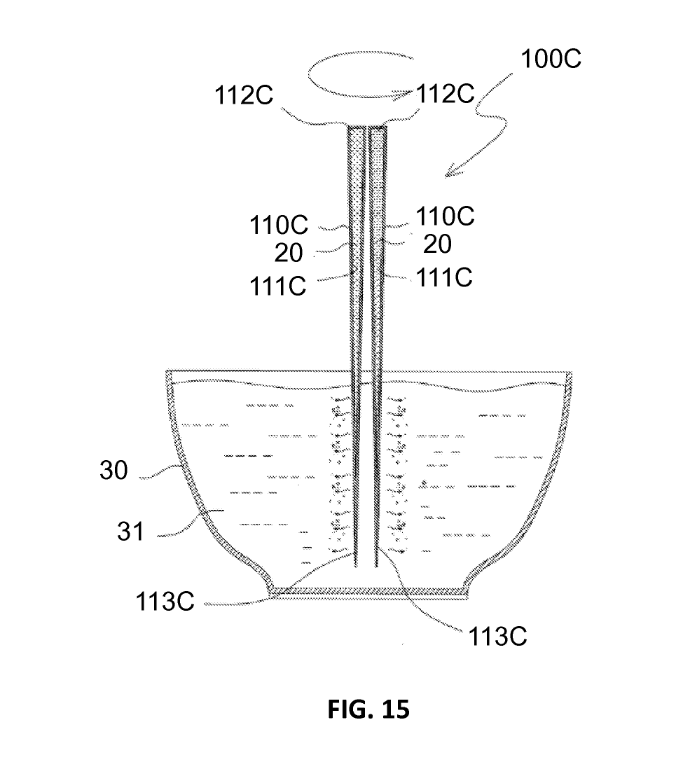

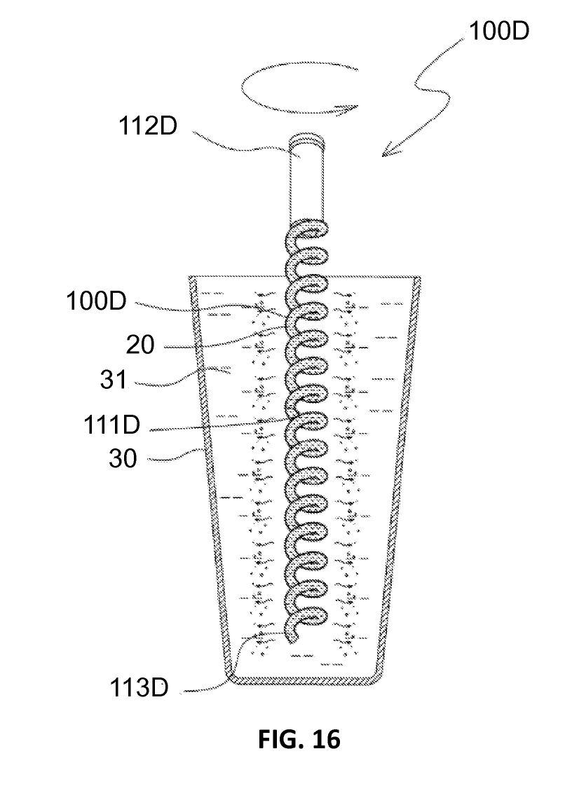

Referring to FIG. 15, a purification stirring rod (100C) has a main body (110C) like a chopstick. The main body (110C) is tapered from a handle portion (112C) to a stirring portion (113C). The main body (110C) has a receiving space (111C) to receive the liquid (20) with resonating molecules. Referring to FIG. 16, a purification stirring rod (100D) has a spiral main body (110D) that has a circular handle (112D) and a spiral stirring portion (113D). Similarly, the main body (110D) has a receiving space (111D) to receive the liquid (20) with resonating molecules.

According to the embodiments stated above, the liquid (20) with resonating molecules in the main body (10) is configured to disperse energy through the wall of the main body (10) to miniaturize the size of the water molecules and further enhance the quality of the water. This water purification apparatus is simple and convenient to use comparing with conventional water purification apparatus.

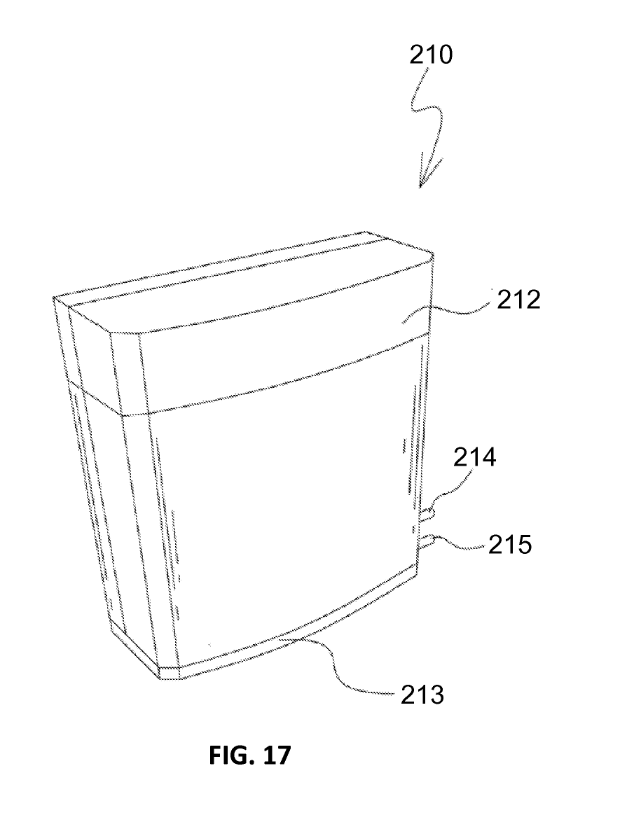

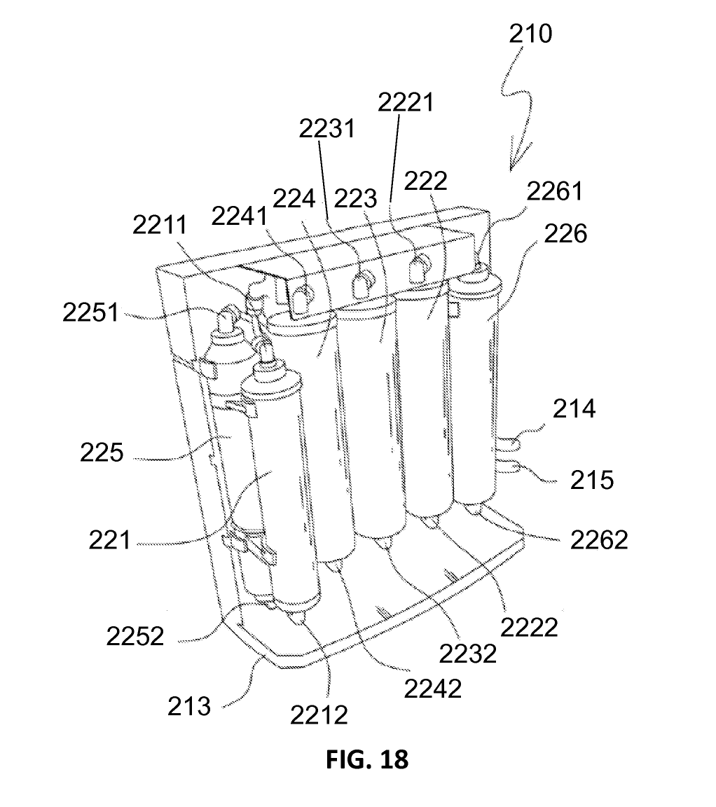

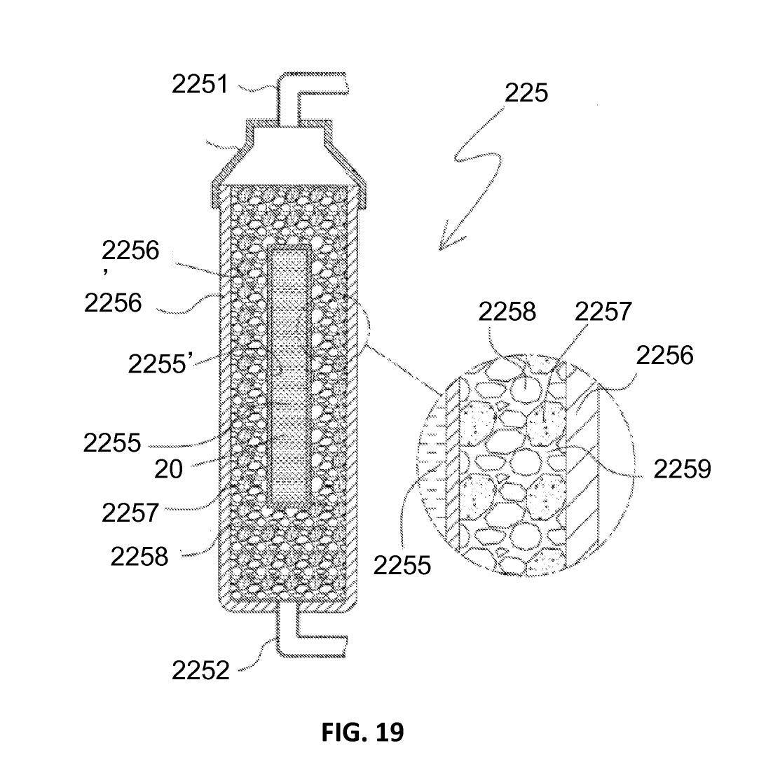

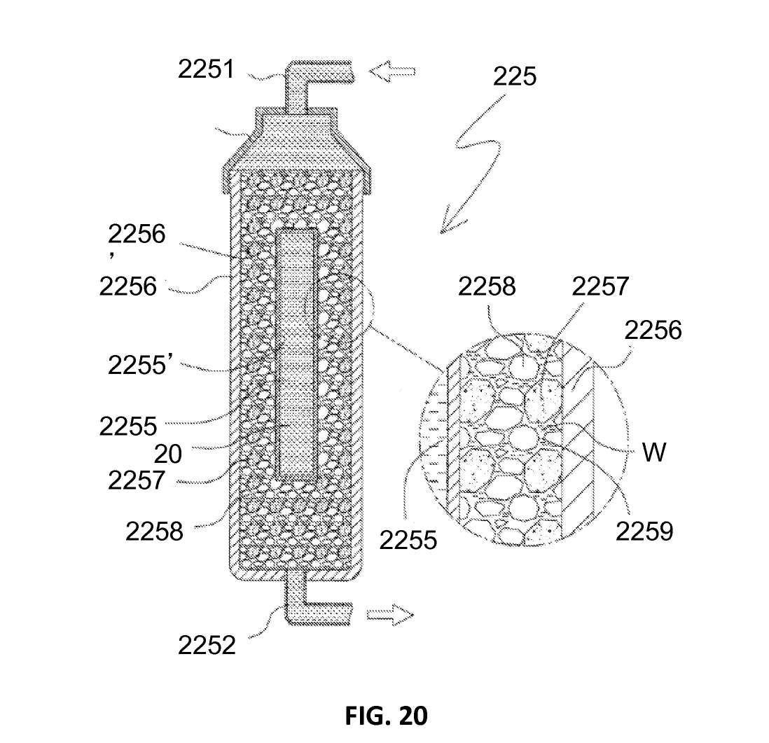

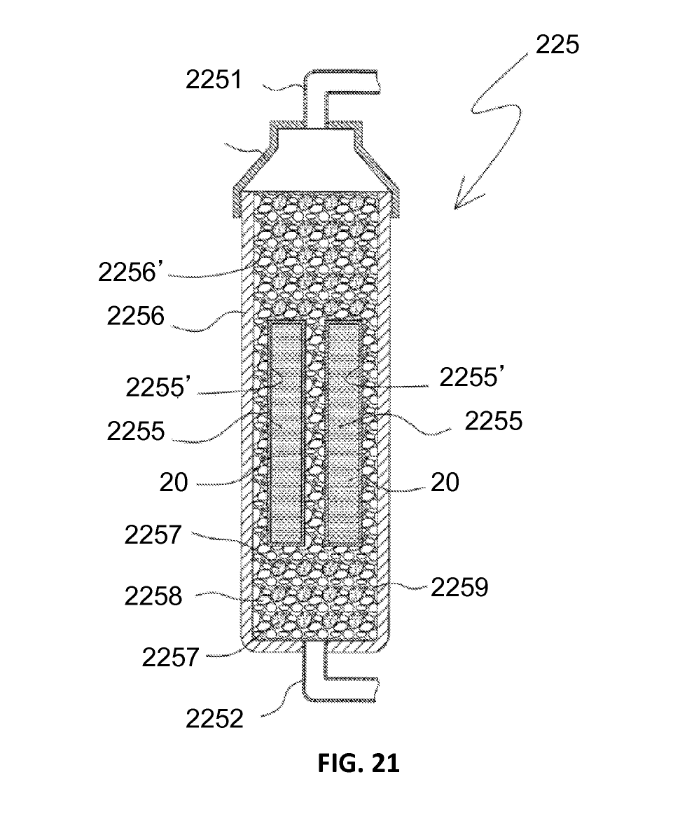

In a further aspect, referring to FIGS. 17 to 21, a water purification system may include a body (210) including a base (213) and a front cover (212) covering the base (213). One side of the body (210) has a water inlet (214) and water outlet (215), and the base (213) has a first filtering unit (221), a second filtering unit (222), a third filtering unit (223), a fourth filtering unit (224), a fifth filtering unit (225) and a sixth filtering unit (226). In one embodiment, the filter of the first filtering unit (221) has an ultra-high density fiber; the filter of the second filtering unit (222) has food-grade ions; the filter of the third filtering unit (223) has high-quality activated carbon particles; the filter of the fourth filtering unit (224) has KDF activated carbon particles; and the filter of the sixth filtering unit (226) is made by advanced ceramic. The first filtering unit (221) has a first water inlet pipe (2211) and a first water outlet pipe (2212) connecting with each other; the second filtering unit (222) has a second water inlet pipe (2221) and a second water outlet pipe (2222) connecting with each other; the third filtering unit (223) has a third water inlet pipe (2231) and a third water outlet pipe (2232) connecting with each other; the fourth filtering unit (224) has a fourth water inlet pipe (2241) and a fourth water outlet pipe (2242) connecting with each other; the fifth filtering unit (225) has a fifth water inlet pipe (2251) and a fifth water outlet pipe (2252) connecting with each other; and the sixth filtering unit (226) has a sixth water inlet pipe (2261) and a sixth water outlet pipe (2262) connecting with each other. The first water inlet pipe (2211) connects with the water inlet (214) of the body (210); the first water outlet pipe (2212) connects with the second water inlet pipe (2221); the second water outlet pipe (2222) connects with the third water inlet pipe (2231); the third water outlet pipe (2232) connects with the fourth water inlet pipe (2241); the fourth water outlet pipe (2242) connects with the fifth water inlet pipe (2251); the fifth water outlet pipe (2252) connects with the sixth water inlet pipe (2261); and the sixth water outlet pipe (2262) connects with the water outlet (215) of the body (210).

The fifth filtering unit (225) further includes a fifth filter (2253) that has a receiving space (2254) and a cover (2255) on top of the fifth filter (2253). An upper portion of the cover (2255) is connected with the fifth water inlet pipe (2251), and a bottom of the fifth filter (2253) is connected to the fifth water outlet pipe (2252). The fifth filtering unit (225) further includes a tubular unit (2256) having a receiving space (2256′) to receive the liquid (20) with resonating molecules; and a plurality of ore units (2257) and ceramic units (2258). A channel (2259) is formed at the gap between the ore units (2257), the ceramic units (2258) and the tubular unit (2256). In an exemplary embodiment, the fifth filtering unit (225) has the fifth filter (2253) including a plurality of ore units (2257), a plurality of ceramic units (2258) and at least one tubular unit (2256), so the water (W) can flow from the water inlet pipe (2251) to the ore units (2257), the ceramic units (2258) and the channel (2259), and the liquid (20) with resonating molecules in the receiving space (2256′) can disperse energy to miniature the size of the water molecules of water (W) to further purify the water (W).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A water purification system comprising:
a water purification unit including a purification space that has a sealing unit at a predetermined position and communicating with outside said water purification unit, said purification space having a receiving space containing liquid with resonating molecules, wherein a purification channel is formed between an outer wall of the receiving space and the purification space, and the purification space has at least one water inlet and one water outlet, and the water inlet is connected to a water source; and
a clean water receiving unit that has a clean water receiving space that has at least one clean water inlet and clean water outlet, wherein the clean water inlet is connected to the water outlet of the purification space to receive clean water that has been processed by the water purification unit.

2. The water purification system of claim 1, wherein the sealing unit has a bolt, a cover and a through hole, said cover secured at one screw end of the purification space and the bolt passing through the through hole.

3. The water purification system of claim 1, wherein the sealing unit is a spiral unit secured at either an upper or a lower portion of the purification space.

4. The water purification system of claim 1, wherein the water inlet and the water outlet of the purification space can connect to a predetermined position of the sealing unit.

5. The water purification system of claim 1, wherein the water purification unit is connected to a faucet outlet, and each of both ends of the water purification space has a securing portion of a connector, and one of the connectors having a positioning portion to position at the faucet outlet.

6. The water purification system of claim 1, wherein the water purification unit is connected to a shower water inlet of a shower head, and each of both ends of the water purification space has a securing portion of a connector, and one of the connectors has a positioning portion to position at the shower water inlet of the shower head.

7. The water purification system of claim 1, wherein the liquid with resonating molecules is processed so the molecules therein resonate at a predetermined frequency to generate energy.

8. A water purification apparatus comprising a main body having a handle on one end, and a stir on the other end, and the main body having a receiving space to receive liquid with resonating molecules.

9. A water purification apparatus of claim 8, wherein the stir is used to stir a sample liquid in a carrier.

10. A water purification apparatus of claim 8, wherein the main body is pen-shaped.

11. A water purification apparatus of claim 8, wherein the main body is spoon-shaped.

12. A water purification apparatus of claim 8, wherein the main body is tapered as a chopstick.

13. A water purification apparatus of claim 8, wherein the main body is spiral.

14. A water purification system comprising a body including a base and a front cover covering the base,
wherein one side of the body has a water inlet and water outlet, and the base has a first filtering, a second filtering unit, a third filtering unit, a fourth filtering unit, a fifth filtering unit and a sixth filtering unit,
wherein the first filtering unit has a first water inlet pipe and a first water outlet pipe connecting with each other; the second filtering unit has a second water inlet pipe and a second water outlet pipe connecting with each other; the third filtering unit has a third water inlet pipe and a third water outlet pipe connecting with each other; the fourth filtering unit has a fourth water inlet pipe and a fourth water outlet pipe connecting with each other; the fifth filtering unit has a fifth water inlet pipe and a fifth water outlet pipe connecting with each other; and the sixth filtering unit has a sixth water inlet pipe and a sixth water outlet pipe connecting with each other,
wherein the first water inlet pipe connects with the water inlet of the body;
the first water outlet pipe connects with the second water inlet pipe; the second water outlet pipe connects with the third water inlet pipe; the third water outlet pipe connects with the fourth water inlet pipe; the fourth water outlet pipe connects with the fifth water inlet pipe; the fifth water outlet pipe connects with the sixth water inlet pipe; and the sixth water outlet pipe connects with the water outlet of the body,
wherein the fifth filtering unit further includes a fifth filter that has a receiving space and a cover on top of the fifth filter, and an upper portion of the cover connected with the fifth water inlet pipe, and a bottom of the fifth filter connected to the fifth water outlet pipe; and a tubular unit having a receiving space to receive the liquid with resonating molecules; and a plurality of ore units and ceramic units, and a channel formed at a gap between the ore units, the ceramic units, and the tubular unit.

15. The water purification system of claim 14, wherein the fifth filtering unit has more than one tubular units.

16. The water purification system of claim 14, wherein the filter of the first filtering unit has an ultra-high density fiber; the filter of the second filtering unit has food-grade ions; the filter of the third filtering unit has high-quality activated carbon particles; the filter of the fourth filtering unit has KDF activated carbon particles; and the filter of the sixth filtering unit is made by advanced ceramic.
